(19) United States
(12) Patent Application Publication
(10) Pub. No.: US 2011/0202650 A1
(43) Pub. Date: Aug. 18, 2011

(54) METHOD AND SYSTEM FOR MONITORING DATA FLOWS IN A NETWORK

(75) Inventors: Vineet M. Abraham, Sunnyvale, CA (US); Sathish K. Gnanasekaran, Sunnyvale, CA (US); Qingyuan Ma, Saratoga, CA (US)

(73) Assignee: BROCADE COMMUNICATIONS SYSTEMS, INC., San Jose, CA (US)

(21) Appl. No.: 12/705,508

(22) Filed: Feb. 12, 2010

(51) Int. Cl. G06F 15/173

(52) U.S. Cl. 709/224

(57) ABSTRACT

One embodiment of the present invention provides a switching system that facilitates data flow monitoring at the logical-unit level. The switching system includes a traffic monitoring mechanism configured to monitor a data flow between a host and a logical unit residing on a target device. The switching system further includes a storage mechanism configured to store data-flow statistics specific to the host and the logical unit and a communication mechanism configured to communicate the data-flow statistics to a traffic management module.

### RELATED APPLICATIONS

The present disclosure is related to U.S. patent application Ser. No. 11/782,894, (attorney docket number 112-0208US), entitled “Method and Apparatus for Determining Bandwidth-Consuming Frame Flows in a Network,” by inventors Amit Kanda and Sathish Kumar Gnanasekaran, filed 25 Jul. 2007, the disclosure of which is incorporated by reference herein.

### BACKGROUND

1. Field

The present disclosure relates to network management. More specifically, the present disclosure relates to a method and system for monitoring data flows in a network.

2. Related Art

The proliferation of the Internet and e-commerce continues to fuel revolutionary changes in the network industry. Today, a significant number of transactions, from real-time stock trades to retail sales, auction bids, and credit-card payments, are conducted online. Consequently, many enterprises rely on existing storage area networks (SANs), not only to perform conventional storage functions such as data backup, but also to carry out an increasing number of egalitarian network functions, such as building large server farms.

Historically, conventional network appliances (e.g., data-center servers, disk arrays, backup tape drives) mainly have used SANs to transfer large blocks of data. Therefore, the switches provide only basic patch-panel-like functions. In the past decade, however, drastic advances occurred in almost all the network layers, ranging from physical transmission media, computer hardware and architecture to operating system (OS) and application software.

For example, a single-wavelength channel in an optical fiber can provide 10 Gbps of transmission capacity. With wavelength-division-multiplexing (WDM) technology, a single strand of fiber can provide 40, 80, or 160 Gbps aggregate capacity. Meanwhile, computer hardware is becoming progressively cheaper and faster. Expensive high-end servers can now be readily replaced by a farm of many smaller, cheaper, and equally fast computers. In addition, OS technologies, such as virtual servers and virtual storage, have unleashed the power of fast hardware and provide an unprecedentedly versatile computing environment.

As a result of these technological advances, a conventional SAN switch fabric faces a much more heterogeneous, versatile, and dynamic environment. The limited network management functions in such switches can hardly meet these demands. For instance, applications are dynamically provisioned on virtual servers and can be quickly moved from one virtual server to another as their workloads change over time. Virtual storage applications automatically move data from one storage tier to another, and these movements are dictated by access patterns and data retention policies. This dynamic movement of application workloads and data can create unexpected bottlenecks, which in turn cause unpredictable congestion in the switch fabric.

### SUMMARY

One embodiment of the present invention provides a switching system that facilitates data flow monitoring at the logical-unit level. The switching system includes a traffic monitoring mechanism configured to monitor a data flow between a host and a logical unit residing on a target device. The switching system further includes a storage mechanism configured to store data-flow statistics specific to the host and the logical unit and a communication mechanism configured to communicate the data-flow statistics to a traffic management module.

In a variation on this embodiment, the traffic monitoring mechanism is configured to obtain information indicating an identifier of the logical unit from the payload of a frame communicated between the host and the target device.

In a variation on this embodiment, the traffic monitoring mechanism includes a statistics-collection mechanism configured to compute a data rate of the data flow over a predetermined period of time.

In a variation on this embodiment, the host and target device are in communication based on a Fibre Channel protocol and a respective logical unit on the target device is identified with a logical-unit number (LUN).

In a further variation, the traffic monitoring mechanism is further configured to identify a respective LUN-level data flow with the corresponding host address, target address, LUN, and flow direction.

In a variation on this embodiment, while communicating the data-flow statistics, the communication mechanism is further configured to transmit the host address, target address, and logical-unit identifier of the corresponding data flow, thereby allowing the traffic management module to throttle the data flow at the logical-unit level.

### BRIEF DESCRIPTION OF THE FIGURES

FIG. 1 illustrates an exemplary FC network that facilitates LUN-level data flow monitoring, in accordance with an embodiment of the present invention.

FIG. 2 illustrates an exemplary FC network with detected bottlenecks and backpressure paths, in accordance with an embodiment of the present invention.

FIG. 3A illustrates an exemplary use of LUN-level data flow monitoring in an FC switch fabric, in accordance with an embodiment of the present invention.

FIG. 3B presents an exemplary time-space diagram illustrating the process of identifying and recording a LUN-level data flow, in accordance with an embodiment of the present invention.

FIG. 4 illustrates an exemplary configuration of counters at an egress switch to monitor LUN-level data flow volumes in an FC switch fabric, in accordance with an embodiment of the present invention.

FIG. 5 presents a flowchart illustrating the process of monitoring data flows at LUN level, in accordance with an embodiment of the present invention.

FIG. 6 illustrates an exemplary architecture of a switch that facilitates logical-unit-level data flow monitoring, in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims.

### Overview

The heterogeneous nature of modern storage area networks imposes many new challenges. In embodiments of the present invention, the problem of monitoring network traffic at a fine-granularity level is solved by facilitating data-flow monitoring on a per logical-device basis. By identifying data flows specific to each logical device residing on a target device, the system can identify data flows between a host and a specific logical device. Hence, embodiments of the present invention can monitor data flows on a logical unit number (LUN) level in a Fibre Channel (FC) network, which has not been possible before. In some embodiments, a set of ingress and egress switches in the FC network are configured to account for data volume at the LUN level. After determining the LUN to which each flow belongs at the ingress or egress switch, counters are periodically updated for each LUN-level flow. LUN-level flows with the highest data volume can be identified and reported to traffic-management modules.

Although the present disclosure is presented using examples in Fibre Channel networks, the disclosed embodiments can be applied in a variety of networks on different layers, such as Internet Protocol (IP) networks and Ethernet networks. The data flow monitoring mechanism disclosed herein can support a variety of protocols, such as the Fibre Channel Over Ethernet (FCOE) protocol and the Metro Ethernet Forum (MEF) specifications.

### Network Architecture

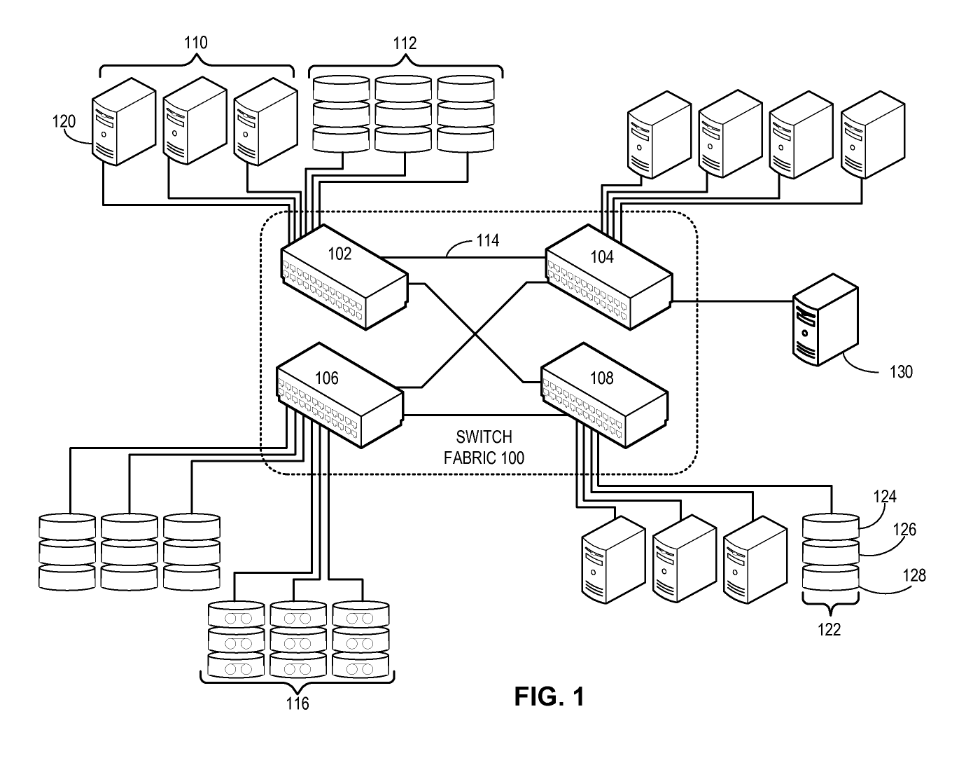

FIG. 1 illustrates an exemplary FC network which facilitates LUN-level data flow monitoring, in accordance with an embodiment of the present invention. In this example, an FC switch fabric 100 includes four switch modules, 102, 104, 106, and 108. Each switch module is coupled to a group of network appliances. For example, switch module 102 is coupled to a number of servers 110 and a number of disk arrays 112.

A respective network host can communicate with a network appliance (referred to as “target”) in the FC network. For example, one of the servers 110 can transfer data to and from one of tape backup devices 116. Since the switch modules are not necessarily coupled in a fully meshed topology, the data frames transferred between servers 110 and tape devices 116 traverse three switch modules 102, 104, and 106. In general, the switch modules are coupled by inter-switch links (ISLs), such as ISL 114.

As shown in FIG. 1, large port-count FC switch fabrics often include a number of smaller, interconnected individual switches. The internal connectivity of a switch fabric can be based on a variety of topologies. In this disclosure, the term “switch fabric” refers to a number of inter-coupled FC switch modules. The terms “switch module” and “switch” refer to an individual switch which can be coupled to other switch modules to form a larger port-count switch fabric. The term “edge device” refers to any network appliance or host, either physical or logical, coupled to a switch.

A switch typically has two types of ports: a fabric port (denoted as F_Port), which can couple to an edge device, and an extension port (E_Port), which can couple to another switch. A host or network appliance communicates with a switch through a host bus adapter (HBA). The HBA provides the interface between a computer's internal bus architecture and the external FC network. An HBA has at least one node port (N_Port), which couples to an F_Port on a switch through an optical transceiver and a fiber optic link. More details on FC network architecture, protocols, naming/address conventions, and various standards are available in the documentation available from the NCITS/ANSI T11 committee (www.t11.org) and publicly available literature, such as “Designing Storage Area Networks,” by Tom Clark, 2nd Ed., Addison Wesley, 2003, the disclosure of which is incorporated by reference in its entirety herein.

Representative problems in an FC network include bottlenecks due to network congestion and spreading of such congestion bottlenecks caused by data-flow back pressure. Bottlenecks are points in a data path where data frames cannot be transmitted as fast as they could. A bottleneck occurs when an outgoing channel in a switch is fed with data frames faster than it is allowed to transmit. Because of the flow-control mechanisms which are commonly present in most networks, a bottleneck spreads upstream along the reverse direction of a data path through backpressure, causing congestion in upstream channels and potentially slowing down other data flows sharing the same path.

In embodiments of the present invention, a switch module (either ingress or egress) can monitor the data flows on a per-logical-device level. In a storage area network, a network appliance (such as a disk array) is often partitioned into logical units. For example, in an FC network that serves as a transport for SCSI storage devices, such a logical unit is identified by a logical unit number (LUN). Typically, multiple logical units share a common address (i.e., the target appliance's physical address, such as a Fibre Channel destination identifier) and a common HBA. Conventional traffic-monitoring techniques implemented at a switch's ingress or egress port can only identify data flows between the addresses of a host and a target device. Consequently, when congestion occurs, the system can only identify which host-target pair is causing the congestion. This solution may not be satisfactory because it could be only a data flow with a particular LUN on that target device that is causing the congestion. Throttling the traffic between the host-target pair may unnecessarily impact the performance of the non-congestion-causing data flows on other LUNs on the same target.

In the example illustrated in FIG. 1, a host 120 is in communication with LUNs 124, 126, and 128, which reside on a target 122. Either ingress switch 102 or egress switch 108 can monitor the traffic between host 120 and target 122. In one embodiment, the monitoring switch can read the payload of the read or write command frames between host 120 and target 122, thereby identifying the LUN-level flow associated with each data frame. The monitoring switch can further maintain a number of counters that accounts for the volume and other traffic statistics (such as latency) specific to the data flows for each LUN.

In some embodiments, a respective switch can report the LUN-level data flow information to a traffic management module 130. Traffic management module 130 can determine which LUN-specific data flow contributes most to a detected bottleneck, and apply an ingress rate limiter to that specific data flow. Note that a separate traffic management module is optional. In some embodiments, the traffic management module can reside with one of the switch modules.

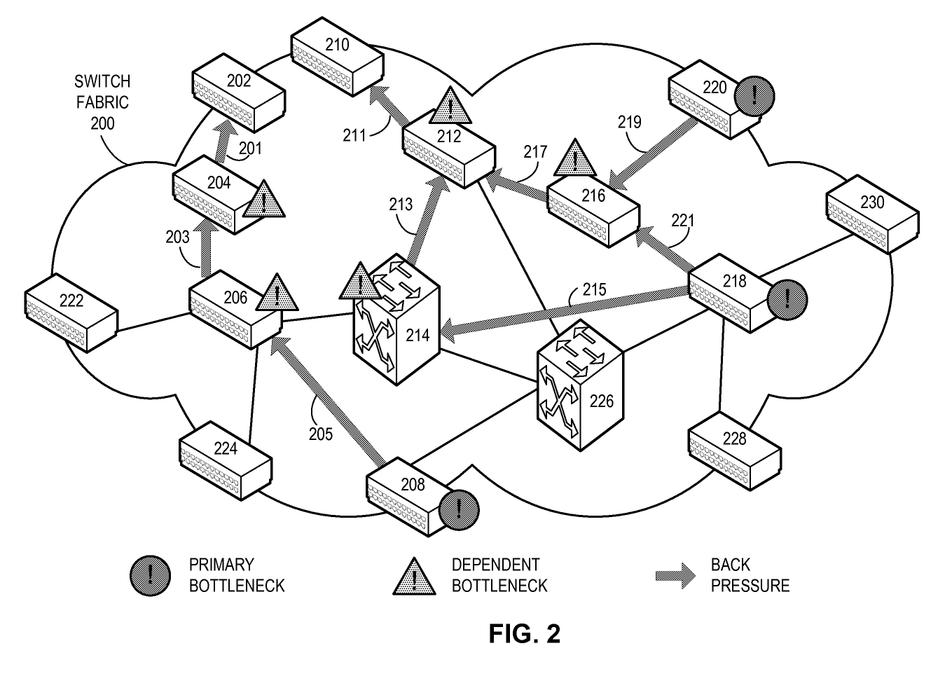

FIG. 2 illustrates an exemplary FC network with detected bottlenecks and backpressure paths, in accordance with an embodiment of the present invention. In this example, congestion occurs at switches 208, 218, and 220, and these three switches become primary bottlenecks. Bottlenecks spread upstream through backpressure, causing other switches along the data paths to become dependent bottlenecks. In FIG. 2, the backpressure paths identified are: (208→206→204→202), (218→214→212→210), (218→216→212→210), and (220→216→212→210). The backpressure path (208→206→204→202) does not share a link or node with the other three backpressure paths and, therefore, is an isolated bottleneck problem.

Data-flow monitoring tools can help eliminate bottlenecks in an FC network by reporting LUN-specific flows that cause the primary bottlenecks. Once the offending flows are determined, ingress rate limiting can be applied to the specific host-LUN pair to reduce the traffic volume of those offending flows and eventually remove the bottlenecks. Knowing which LUN-specific flows are causing congestions helps determine where to set ingress rate limits to remove bottlenecks. Embodiments of the present invention facilitate such a data-flow monitoring system that discovers and reports top flows with the highest data volume at LUN level. The monitoring system reports the data flows that are carrying the most traffic volume upon query. The report on top LUN-level flows can also be processed to generate fabric-wide tabulation of which application workloads consume the most fabric bandwidth.

### LUN-Level Data Flow Monitoring

A logical unit number, or LUN, is the identifier of an FC or iSCSI logical unit. For example, an FC target address can have 32 LUNs assigned to it, addressed from zero to 31. Each LUN may refer to a single disk, a subset of a single disk, or an array of disks. In embodiments of the present invention, data flows can be identified at the LUN-level granularity by a 3-tuple {SID, DID, LUN} and the direction of the flow (i.e., write or read). SID and DID refer to the FC address (identifier) of the source (typically the host) and destination (typically the target), respectively. An SID or DID uniquely identifies an edge device in an FC network. This 3-tuple can identify a specific flow between a host (SID) and a LUN on a target (DID). The flow direction (i.e., write or read) indicates whether the flow is from the host to the LUN device (for a write command), or from the LUN device to the host (for a read command). The LUN-level data flow monitoring mechanism can report detailed fabric bandwidth consumption at the granularity of application workloads.

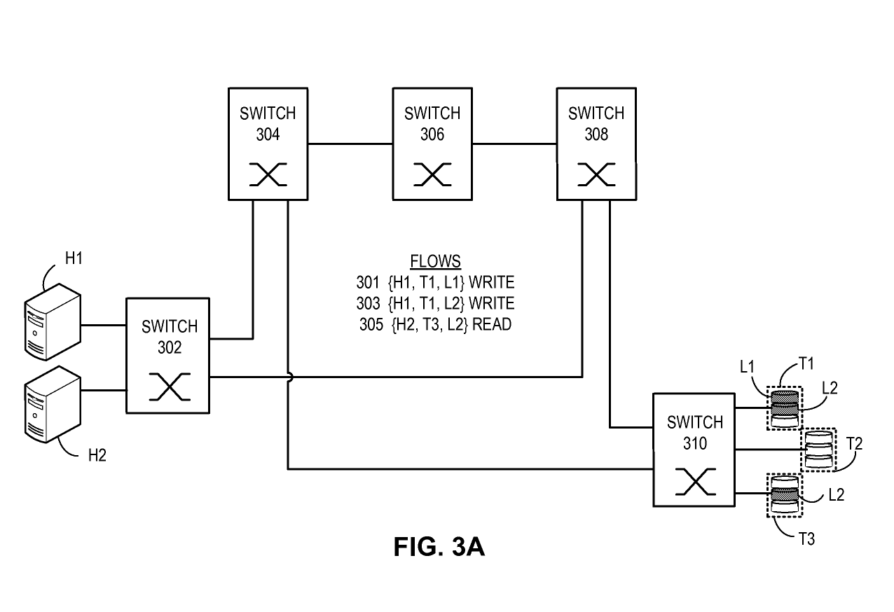

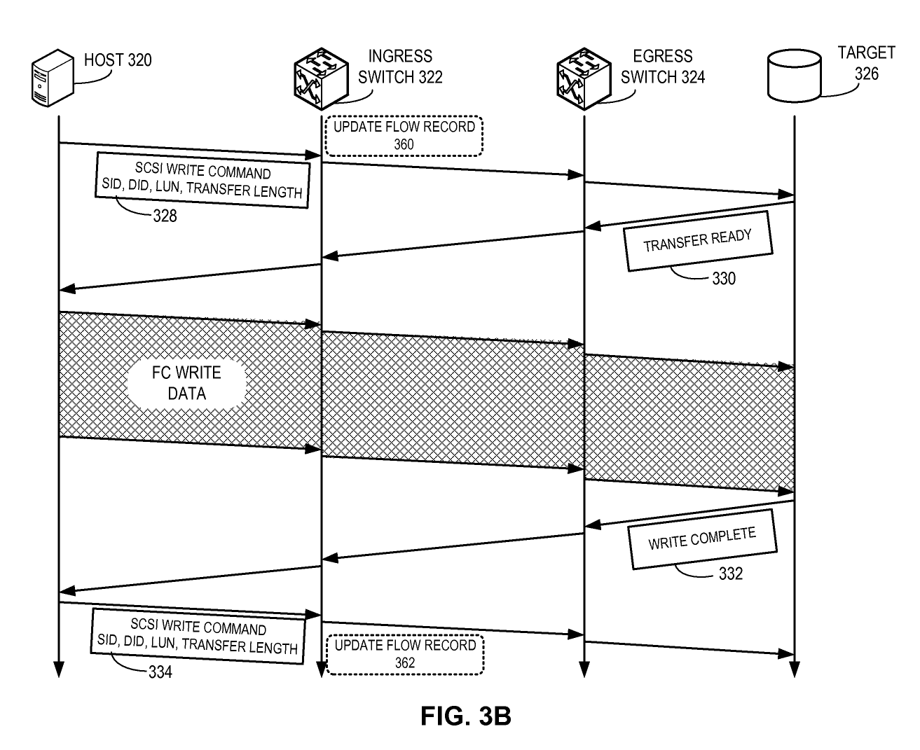

In order to determine the LUN to which each flow belongs, the data flow monitoring system intercepts connection setup frames at the ingress or egress switches. A connection setup frame include a connection request from the host to the target. In one embodiment, the connection request includes an FC header (which includes the corresponding SID and DID), and a SCSI command descriptor block (CDB). The CDB typically identifies the LUN, the command (e.g., write or read), and transfer data length. As explained in more details below in conjunction with FIG. 3B, the system can identify a flow by the 3-tuple {SID, DID, LUN} and the flow direction, and account for the volume of the data flow based on the transfer data length. The ingress and egress switches maintain synchronized databases of the existing data flow identifiers (i.e., the 3-tuples plus the flow direction) in the FC network. Newly identified flow IDs can be added to the database when a write or read command is detected. The flow IDs at an ingress or egress switch can be sent to the corresponding egress or ingress switches for synchronization. Since a write or read session can include multiple transfer commands, a monitoring switch maintains a counter for the data transferred within each LUN-level data flow. This counter is updated upon detection of a write or read command frame. The monitoring switch can periodically report the volume of each flow being monitored based on the corresponding counter values. For example, the bandwidth consumed by a respective data flow can be computed by dividing the cumulative transferred data volume in bytes with the total amount of time over which the data is transferred. The LUN-level flow IDs and their corresponding traffic statistics maintained at such databases facilitate LUN-level diagnostics and assist network provisioning.

FIG. 3A illustrates an exemplary use of LUN-level data flow monitoring in an FC switch fabric, in accordance with an embodiment of the present invention. In this example, hosts H1 and H2 are coupled to a switch 302. Targets T1, T2, and T3 are coupled to a switch 310. Switches 302 and 310 are coupled through switches 304, 306, and 308. Three data flows are active in the FC switch fabric: 301 {H1, T1, L1}/write, 303 {H1, T1, L2}/read, and 305 {H2, T3, L2}/write. Flow 305 is between H2 and T3 and accessing LUN L2 for a read command. Both flows 301 and 303 are between H1 and T1 and for write commands. However, within target T1, flow 301 is targeting LUN L1, while flow 303 is targeting LUN L2. Flows 301 and 303 are each identified by their respective 3-tuples. Note that flows 301 and 303 may take different routes due to different quality of service (QoS) requirements.

During operation, either one or both of switches 302 and 310 can maintain a table which records traffic statistics of flows 301, 303, and 305. Such traffic statistics may include, but are not limited to: average data rate (computed over a relatively long period), burst data rate (computed over a relatively short period), average end-to-end latency, and current end-to-end latency. In one embodiment, a traffic management system can identify the network bottlenecks and their corresponding data paths. These data paths can be identified by the ingress port on an ingress switch and egress port on an egress switch. The LUN-level data flow databases maintained on these switches can then be used to identify the LUN-level data flows that contribute to these bottleneck data paths. As a result, ingress rate limiters can be applied to those LUN-level data flows that contribute most to the identified bottlenecks.

FIG. 3B presents an exemplary time-space diagram illustrating the process of identifying and recording a LUN-level data flow, in accordance with an embodiment of the present invention. In this example, a host 320 initiates a write session with a target 326. The write session is transported over an FC network and the data path traverses an ingress FC switch 322 and an egress FC switch 324. Note that a write session typically include a number of transfers, each of which is initiated with a separate write command.

During operation, host 320 first sends a write request frame 328 to target 326. Write request frame 328 specifies the source ID of host 320 (SID) and destination ID of target 326 (DID). Furthermore, write request frame 328 includes a SCSI write command specified by a command descriptor block (CBD). The CBD includes the target LUN, the logical block addressing (which indicates the logical address at which the write operation occurs), and a transfer data length.

Upon receiving frame 328, ingress switch 322 obtains the parameters of this write session, namely the SID, DID, LUN, command type (which is write in this example, indicating that the data flow is from host 320 to target 326), and transfer data length. Switch 322 then updates a corresponding flow record identified by the 3-tuple {SID, DID, LUN} and the flow direction (operation 360). Subsequently, frame 328 is forwarded by egress switch 324 and reaches target 326.

In response, target 326 sends back an acknowledgment frame 330, which indicates that the associated LUN is ready to receive the write data.

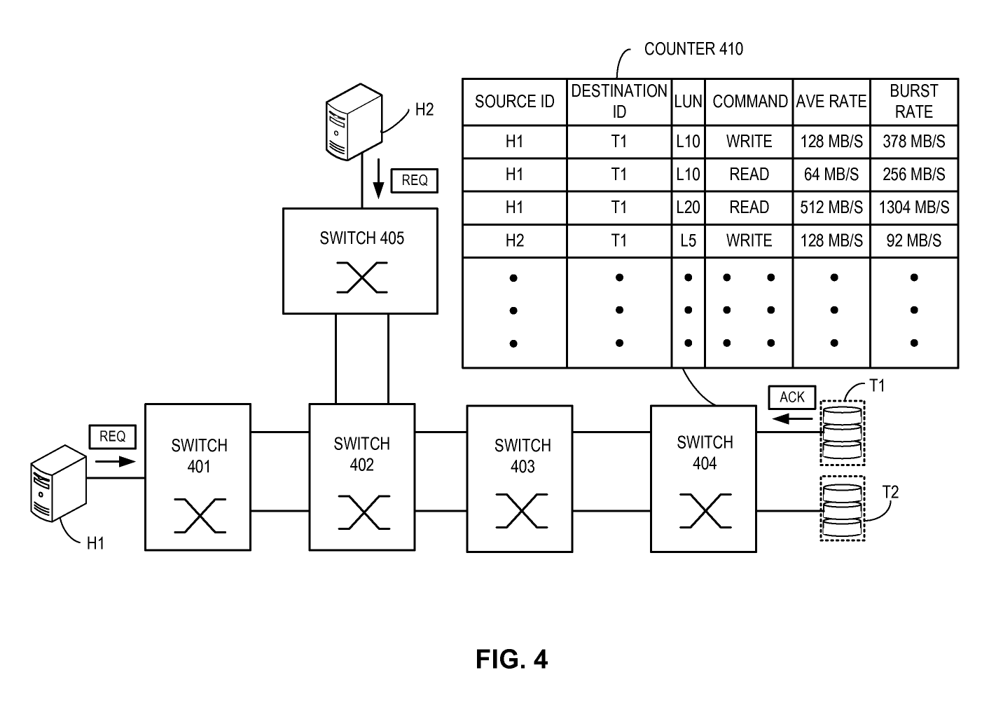

After host 320 receives the acknowledgment frame 330 from target 326, host 320 commences the write data transfer. After the data transfer is complete, target 326 sends a frame 332 notifying host 320 that all the write data has been received. In response, host 320 transmits the next write command frame 334 to transfer subsequent write data in the write session. Correspondingly, ingress switch 322 updates the flow record with the parameters included in write command frame 334. FIG. 4 illustrates an exemplary configuration of counters at an egress switch to monitor LUN-level data flow volumes in an FC switch fabric, in accordance with an embodiment of the present invention. As shown in FIG. 4, a switch 401 is coupled to a host H1, and a switch 405 is coupled a host H2. A switch 404 is coupled to disk arrays T1 and T2. Switches 401, 405, and 404 are configured with counters for LUN-level data flow monitoring. Flow IDs are determined at switches 401 and 405 or switch 404 when hosts H1 and H2 send out data-transfer request frames to target T1. A counter 410 in switch 404 is shown to contain the 3-tuples {SID, DID, LUN} and their corresponding flow direction (represented by the write or read command) for flow identification and two counter fields for maintaining records of each data flow's average data rate and burst data rate. Here the average data rate is computed over a relatively long period, such as 30 minutes. The burst data rate is computed over a relatively short period, such as 10 seconds. In this example, there are two distinctive flows between H1 and LUN L10 on T1, identified as {H1, T1, L10}/write and {H1, T1, L10}/read, respectively. Another flow exists between H1 and LUN L20 on T1, as identified by as {H1, T1, L20}/read. This flow has both the highest average data rate and the highest burst data rate. If there is a congested data path between H1 and T1, reducing the traffic volume of data flow between H1 and L20 on T1 would be most effective without impacting other flows between H1 and L10 on T1.

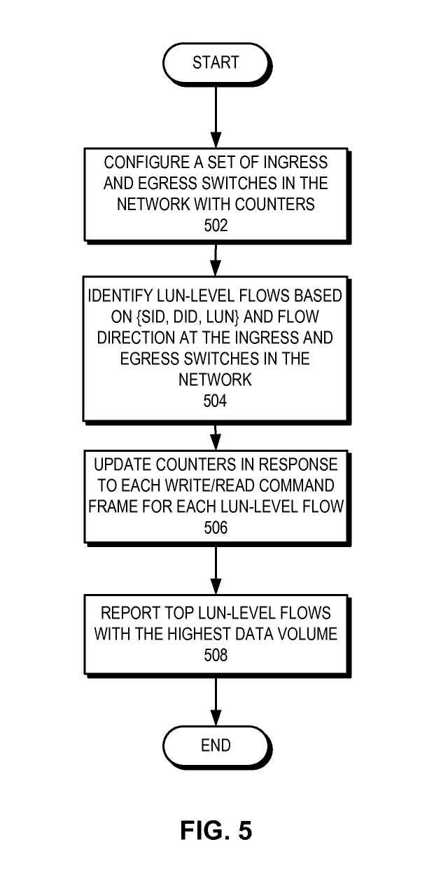

FIG. 5 presents a flowchart illustrating the process of monitoring data flows at LUN level, in accordance with an embodiment of the present invention. During operation, the LUN-level data monitoring system first configures a set of ingress and egress switches in the FC network with counters for counting the data rate of data flows (operation 502). The system next identifies LUN-level flows based on 3-tuples {SID, DID, LUN} and the flow direction by analyzing the command frames (operation 504). Subsequently, the system updates counters in response to each write/read command frame for each LUN-level flow (operation 506). The system can further report top LUN-level flows with the highest data volume to a traffic management module (operation 508).

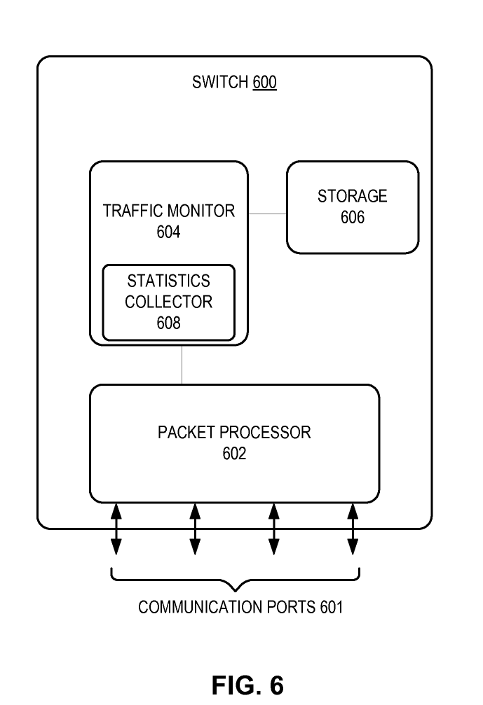

FIG. 6 illustrates an exemplary architecture of a switch that facilitates logical-unit-level data flow monitoring, in accordance with one embodiment of the present invention. In this example, a switching system 600 includes a number of communication ports 601. A respective communication port is coupled to a transceiver which facilitates bi-directional (ingress and egress) communication. Coupled to the communication ports is a packet processor and switch 602. Packet processor 602 is responsible for reading each incoming data frame's header information and performing the proper switching of the data frame based on the header information. In addition, packet processor 602 can analyze a command frame to identify the LUN information. Note that, in conventional switches, the packet processor typically does not parse the payload information beyond the FC headers. In embodiments of the present invention, the payload (including the SCSI frame) is parsed and additional header information carried therein is used to identify the LUN information.

Also included in switch 600 is a traffic monitor 604, which includes a statistics collector 608. Traffic monitor 604 maintains a record of each LUN-level data flow, which are stored in storage 606. Statistics collector 608 collects traffic statistics, such as average/current data rate and average/current latency, of each LUN-level data flow. The state of each LUN-level data flow and the collected statistics information are stored in storage 606. Traffic monitor 604 can periodically report the contents stored in storage 606 to a traffic management module via any of the communication ports 601. In addition, traffic monitor 604 can provide LUN-level data flow information upon receiving a properly authenticated request from the traffic management module.

Note that although the example illustrated in FIG. 6 is based on a FC switch, the architecture described therein can be applied to a variety of switches, such as Ethernet switches and IP routers.

In summary, embodiments of the present invention facilitate LUN-level data flow monitoring in an FC network. The data flow monitoring system configures a set of ingress and/or egress switches in the FC network with counters for collecting data flow information at LUN level. After determining LUNs to which each flow belongs at the ingress or egress switches, the system updates counters periodically for each LUN-level flow, and reports the LUN-level data flow statistics to a traffic management module. Although the example provided in this description are based on SCSI communication protocols, embodiments of the present invention can be applied with other storage-device-level protocols.

The foregoing descriptions of embodiments of the present invention have been presented only for purposes of illustration and description. They are not intended to be exhaustive or to limit this disclosure. Accordingly, many modifications and variations will be apparent to practitioners skilled in the art. The scope of the present invention is defined by the appended claims.

The methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them. The foregoing descriptions of embodiments of the present invention have been presented only for purposes of illustration and description. They are not intended to be exhaustive or to limit this disclosure. Accordingly, many modifications and variations will be apparent to practitioners skilled in the art. The scope of the present invention is defined by the appended claims.

What is claimed is:

1. A switching system, comprising:
a traffic monitoring mechanism configured to monitor a data flow between a host and a logical unit residing on a target device;
a storage mechanism configured to store data-flow statistics specific to the host and the logical unit; and
a communication mechanism configured to communicate the data-flow statistics to a traffic management module.

2. The switching system of claim 1, wherein the traffic monitoring mechanism is configured to obtain information indicating an identifier of the logical unit from the payload of a frame communicated between the host and the target device.

3. The switching system of claim 1, wherein the traffic monitoring mechanism comprises a statistics-collection mechanism configured to compute a data rate of the data flow over a predetermined period of time.

4. The switching system of claim 1, wherein the host and target device are in communication based on a Fibre Channel protocol; and
wherein a respective logical unit on the target device is identified with a logical-unit number (LUN).

5. The switching system of claim 4, wherein the traffic monitoring mechanism is further configured to identify a respective LUN-level data flow with the corresponding host address, target address, LUN, and flow direction.

6. The switching system of claim 1, wherein while communicating the data-flow statistics, the communication mechanism is further configured to transmit the host address, target address, and logical-unit identifier of the corresponding data flow, thereby allowing the traffic management module to throttle the data flow at the logical-unit level.

7. A method, comprising:
monitoring a data flow between a host and a logical unit residing on a target device;
storing data-flow statistics specific to the host and the logical unit; and
communicating the data-flow statistics to a traffic management module.

8. The method of claim 7, wherein monitoring the data flow comprises obtaining information indicating an identifier of the logical unit from the payload of a frame communicated between the host and the target device.

9. The method of claim 7, wherein monitoring the data flow comprises computing a data rate of the data flow over a predetermined period of time.

10. The method of claim 7, wherein the host and target device are in communication based on a Fibre Channel protocol; and
wherein the method further comprises identifying a respective logical unit on the target device with a logical-unit number (LUN).

11. The method of claim 10, monitoring the data flow comprises identifying a respective LUN-level data flow with the corresponding host address, target address, LUN, and flow direction.

12. The method of claim 7, wherein communicating the data-flow statistics comprises transmitting the host address, target address, and logical-unit identifier of the corresponding data flow, thereby allowing the traffic management module to throttle the data flow at the logical-unit level.

13. A switching means, comprising:
a traffic monitoring means for monitoring a data flow between a host and a logical unit residing on a target device;
a storage means for storing data-flow statistics specific to the host and the logical unit; and
a communication means for communicating the data-flow statistics to a traffic management module.

14. The switching means of claim 13, wherein the traffic monitoring means comprises a logical-unit identification means for obtaining information indicating an identifier of the logical unit from the payload of a frame communicated between the host and the target device.

15. The switching means of claim 13, wherein the traffic monitoring means comprises a statistics-collection means for computing a data rate of the data flow over a predetermined period of time.

16. A network, comprising:
an ingress switch;
an egress switch;
a traffic monitoring mechanism residing on the ingress switch, the egress switch, or both, wherein the traffic monitoring mechanism is configured to monitor one or more data flows between a host coupled to the ingress switch and a target device coupled to the egress switch on a per-logical-unit basis.

17. The network of claim 16, wherein the network is a Fibre Channel network, and wherein a respective logical unit on the target device is identified by a logical-unit number (LUN).

18. The network of claim 16, further comprising a traffic management module configured to receive logical-unit-level data-flow information from the ingress switch, the egress switch, or both.

19. The network of claim 18, wherein the traffic management module is configured to determine a data flow between a host and a logical unit residing on a target device which contributes most to a detected network bottleneck.

20. The network of claim 18, wherein the traffic monitoring mechanism is configured to identify a logical unit by analyzing the payload of a data frame.
